(19) United States
(12) Patent Application Publication
(10) Pub. No.: US 2013/0229704 A1
(43) Pub. Date: Sep. 5, 2013

(54) GRADED INDEX METAMATERIAL LENS

(71) Applicant: Igor I. Smolyaninov, Columbia, MD (US)

(72) Inventor: Igor I. Smolyaninov, Columbia, MD (US)

(73) Assignee: BAE Systems Information and Electronic Systems Integration Inc., Nashua, NH (US)

(21) Appl. No.: 13/885,713

(22) PCT Filed: Aug. 20, 2012
(86) PCT No.: PCT/US12/51547

§ 371 Date: May 16, 2013

Related U.S. Application Data
(60) Provisional application No. 61/529,444, filed on Aug. 31, 2011.

(51) Int. Cl. G02B 13/14

(52) U.S. Cl. CPC G02B 13/14
USPC 359/356

(57) ABSTRACT

A lens with a graded index of refraction is presented. The lens is formed out of a sheet of material having a uniform thickness with a top surface and a bottom surface. Elongated openings are formed in the top surface extending downwardly to the bottom surface. Material of the elongated sheet is left between adjacent openings. A width of the material between adjacent openings is less than a wavelength of electromagnet energy the lens is configured to refract. The density and distribution openings varies across the sheet of material so that the refractive index of the lens varies across the sheet of material.

### BACKGROUND

1. Field of Invention

The current invention relates generally to apparatus, systems and methods for refracting light. More particularly, the apparatus, systems and methods relate to a flat lens for refracting light. Specifically, the apparatus, systems and methods provide for refracting light that passes through a sheet of material with small openings in it.

2. Description of Related Art

Large lenses that are used to refract light are often large, very difficult to accurately construct, and they can be very expensive. For example, germanium lenses for use in the Long-Wave Infrared (LWIR) range are expensive and heavy while flat Fresnel lenses may tend to have poor resolution and strong dispersion. Therefore a need exists for a better lightweight and inexpensive lens that has favorable resolution and dispersion characteristics.

### SUMMARY

The preferred embodiment of the invention includes a flat lens formed of solid material with openings smaller than the wavelength for light or other electromagnetic radiation) that it is to refract. The material can be a metamaterial that may be mass fabricated on the surface of a thin silicon wafer. The metamaterial lens can have an engineered profile of a refractive index gradient by controlling the density of holes formed in different areas of the material. This lens can be used for LWIR purposes.

One configuration of the preferred embodiment includes a lens with a graded index of refraction. The lens is formed out of a sheet of material having a uniform thickness with a top surface and a bottom surface. Elongated openings are formed in the top surface and extend downwardly to the bottom surface. Material of the elongated sheet is left between adjacent openings. A width of the material between adjacent openings is less than a wavelength of the electromagnet energy that the lens is configured to refract. The density and distribution of the openings vary across the sheet of material so that the refractive index of the lens varies across the sheet of material.

In other configurations of the preferred embodiment, features on the top surface of the sheet of material are less than the wavelength of the electromagnet energy the lens is configured to refract. For example, the distances across the openings on the top surface are less than the wavelength of electromagnet energy that the lens is configured to refract.

In other embodiments, the lens can have other useful features and characteristics. For example, the sheet of material can be formed out of a metamaterial. In some embodiments, metal filling can fill the elongated openings. The metal filling can be aluminum, copper or another metal. The refractive index of the material can be between 0 and 3.5.

### BRIEF DESCRIPTION OF SEVERAL VIEWS OF THE DRAWINGS

The present application contains at least one drawing executed in color. Copies of this patent or patent application publication with color drawing(s) will be provided by the Office upon request and payment of the necessary fee.

One or more preferred embodiments that illustrate the best mode(s) are set forth in the drawings and in the following description. The appended claims particularly and distinctly point out and set for the invention.

The accompanying drawings, which are incorporated in and constitute a part of the Specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIGS. 1A and 1B are example cross-sectional views of the preferred embodiment of a graded index material geometry. Density of air holes (that may be partially open chambers) define the effective refractive index in the 1<n<3.5 range, while 0<n<1 range may be achieved using aluminum filling (or another type of filling) in the air holes.

FIGS. 2A-C illustrates example top views of the preferred embodiment of a graded index material of FIG. 1.

FIG. 3 illustrates that graded index material design achieves diffraction-limited focusing with little to no chromatic aberration.

FIGS. 4A-D are color photographs illustrating COMSOL simulations of electromagnetic (EM) fields in various refractive elements: (A) EM field around a prism element, (B) refractive index distribution in a small element of graded index metamaterial lens, (C) EM field around a graded index lens element calculated at λ=12 μm, (D) EM field around a graded index lens element calculated at λ=8 μm; and

FIG. 5 is an example schematic drawing illustrating the replacements of the expensive front lens piece in the fisheye WATIR design with a graded index metamaterial lens.

FIG. 6 is an example configuration of the preferred embodiment of the invention configured as a method of passing electromagnetic radiation through a thin sheet of material and refracting the electromagnetic radiation with the material.

Similar numbers refer to similar parts throughout the drawings.

### DETAILED DESCRIPTION

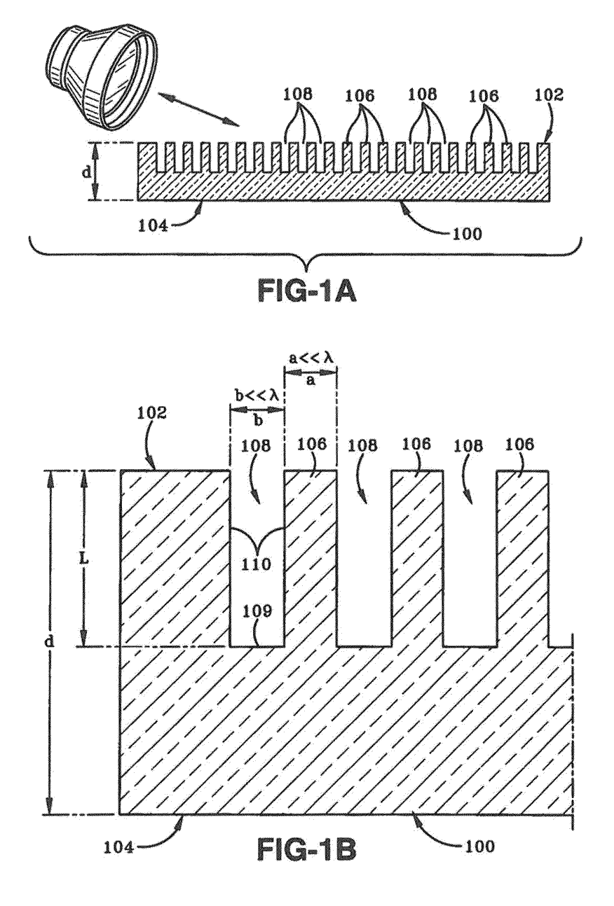

FIGS. 1A and 1B illustrate cross-sectional side views of the preferred embodiment of a lens 100 for refracting light (or any electromagnetic radiation). The lens 100 is formed out of a material with a top surface 102, a bottom surface 104, and openings 108 (holes) extending from the top surface 102 at least partially downwardly towards the bottom surface 104. In the preferred embodiment, the openings 108 extend a distance L from the top wall 102 downward to a bottom opening wall 109 so that the openings 108 do not pass completely through the material of the lens 100. In other configurations of the preferred embodiment, the openings 108 can pass completely through the material of the lens 100. In the preferred embodiment, the openings 108 are formed with generally parallel side walls 110. The openings 108 can be square, round, rectangular or another shape of opening.

In the preferred embodiment, the openings 108 are adjacent upward pointing material 106 that is left after the openings 108 are formed. The width ‘a’ of material 106 between openings 108 is significantly less than the wavelength “λ” of light that is to be refracted by the lens 100. In some configurations, the width of the openings “b” is also significantly less than the wavelength “λ” of light that is to be refracted by the lens 100.

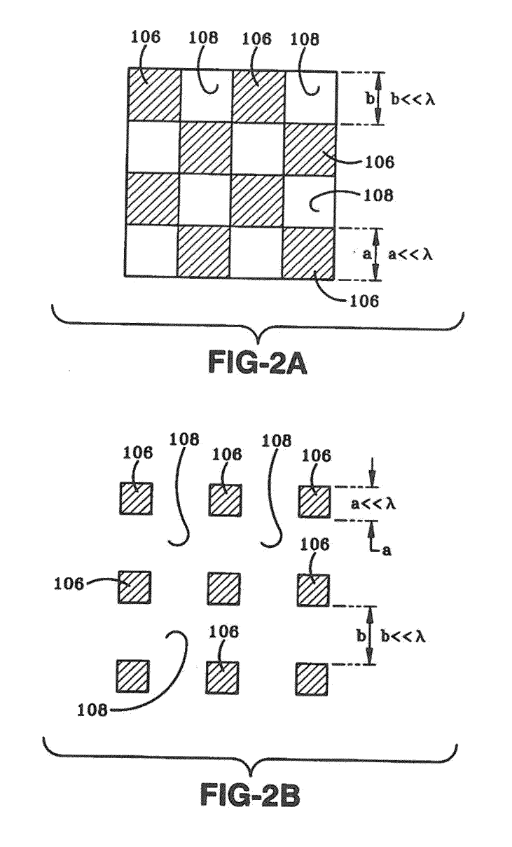

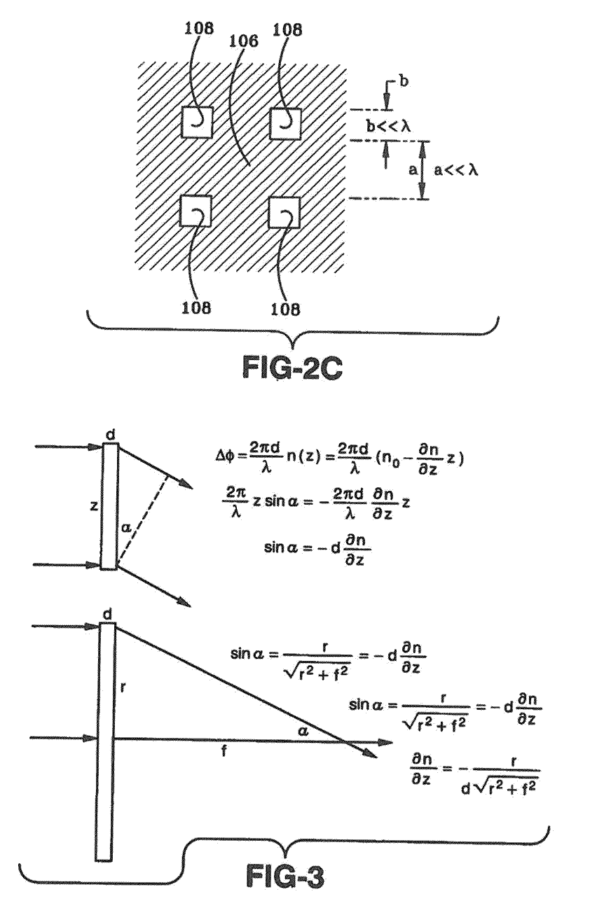

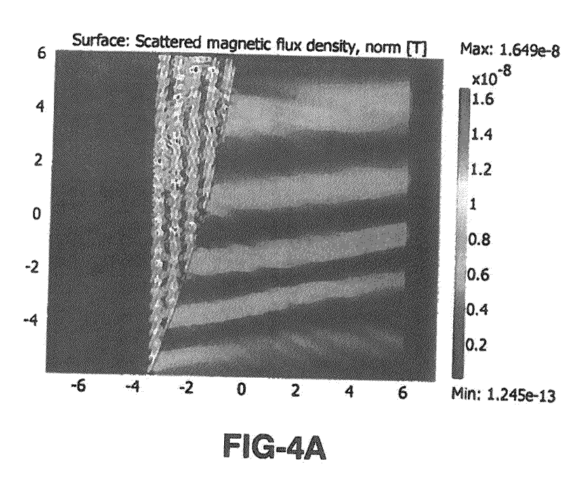

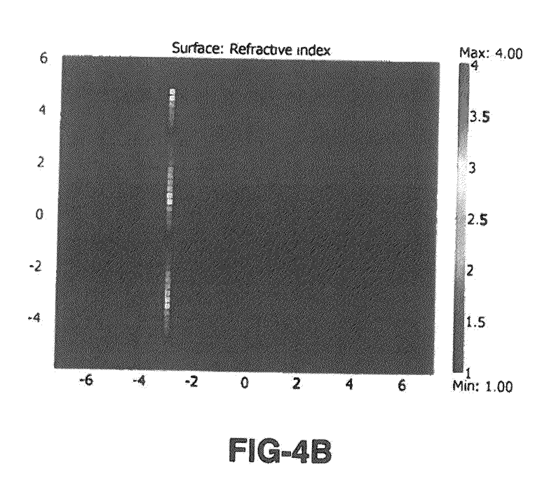

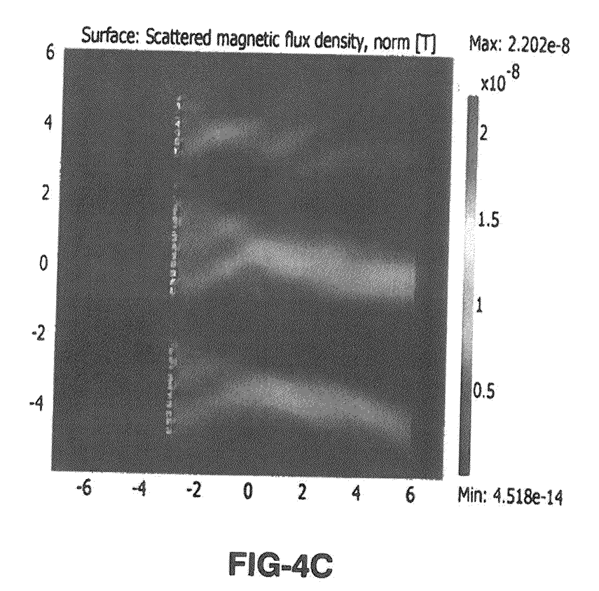

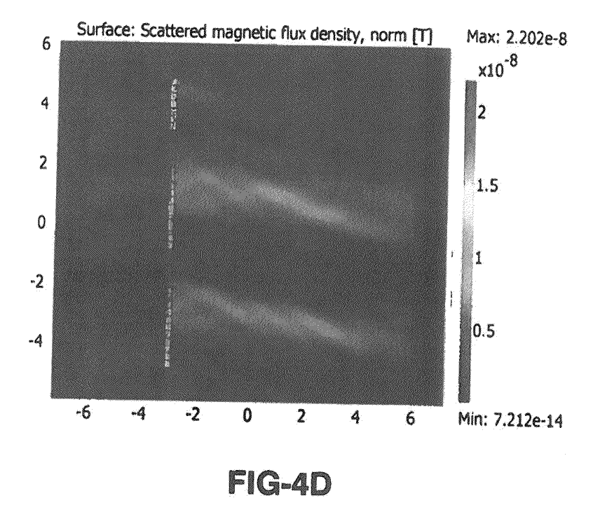

FIGS. 2A-C illustrate example top views of the lens 100 with square openings 108 and square material 106 between the openings 108. Of course, as already mentioned, the openings 108, as well as the material 106 left between the openings 108, can be shapes other than the square shape illustrated. In FIG. 2A, the size of the material 106 between the openings 108 is about the same. In FIG. 2B, the size of the material 106 between openings 108 is smaller than the size of the openings 108. In FIG. 2C, the size of the material 106 between openings 108 is larger than the size of the openings 108. Because the size of the openings 108 and the opening density is different in FIGS. 2A, 2B and 2C, the corresponding refractive index is different for the lens represented by each of FIGS. 2A, 2B and 2C. In the preferred embodiment, the lens 100 is a graded metamaterial lens with a density of openings that changes across the span of the lens 100 as illustrated in FIG. 4B.

For example, the lens 100 can be formed from a metamaterial implemented in the form of a flexible thin silicon (Si) membrane. The lens 100 might be used to simplify the wide-angle thermal infrared (WATIR) lens based on a commonly used fisheye design. The lens 100 illustrated in the Figures offers realistic and economically beneficial utilization of materials that include metamaterials developed for the optical domain. For example, a graded index metamaterial lens design can replace expensive and heavy GE lenses and can implement low cost lithography. Metamaterial feature sizes “a” and “b” are ideally roughly 1/10th the wavelength of the radiation “λ” which implies that the lens design only requires about one micron scale structures. Conventional semiconductor techniques can make this scale of structures using visible wavelength photolithography. This means that large area lenses (two to five inches in diameter) do not require expensive e-beam fabrication, and the fabrication costs can leverage the infrastructure already in place at BAE Systems. Conservatively assuming a meta-lens could remove three of five lenses at a cost savings of 50% implies a considerable unit cost reduction accompanied by considerable reduction in weight of the optical assembly.

In the preferred embodiment, the lens design is based on the “graded index metamaterial” concept as shown in FIG. 3. The equations in FIG. 3 are derived by applying Snell's law to the lens 100 of FIGS. 1A-B where “d” is the thickness of the lens 100, “r” is its radius and “f” is its focal length. Unlike a flat Fresnel lens design, a flat graded index metamaterial lens has almost no chromatic aberration since the periodicity of the metamaterial structure a<<λ. This feature is made possible by large values of λ the LWIR range. On the other hand, due to limited range of available refractive indices n, the graded index metamaterial lens must be separated into multiple elements while keeping the required value of the index gradient dn/dr shown in FIG. 3. Electromagnetic simulations using COMSOL multiphysics (described below) indicate that this will lead to small amount of wavelength-independent scattering. Therefore, the only source of chromatic aberration in this design is the wavelength dependence of the refractive index n(λ), and in a thin lens design chromatic aberration, is very small. As a result, typical ray tracing software like CODE V perceives the graded index metamaterial lens design as almost “ideal”.

Scattering effects must be taken into account by full wave EM simulations using COMSOL Multiphysics. Results of these simulations are shown in FIGS. 4A-D. In these simulations, large elements of the graded index metamaterial lens 100 look the same as similarly sized refractive prism elements. No more than 10% of the optical power goes into the scattered channels. In addition, COMSOL simulations performed at different wavelengths within the 8-12 μm range confirm close to zero chromatic aberration of the lens (compare FIGS. 4C and 4D).

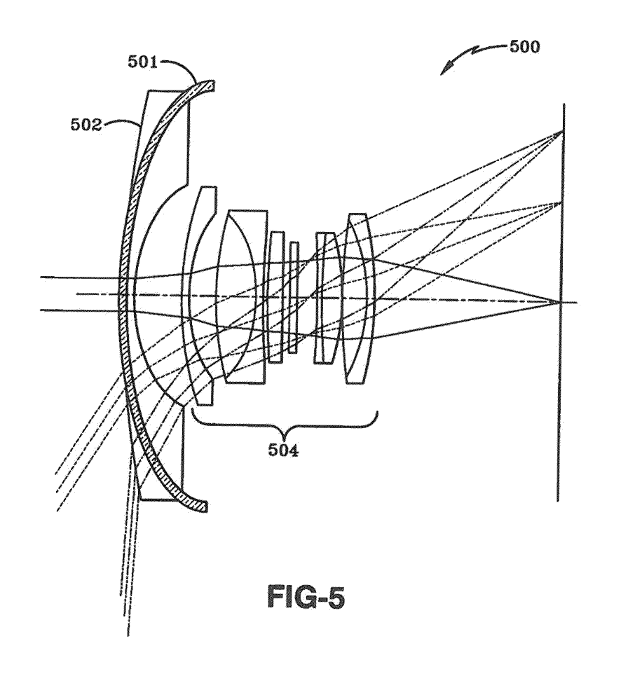

The described technical approach can be implemented to virtually any optical assembly. In narrow field of view (FOV) systems, such as TIM1500, it is sufficient to use a front flat graded index metamaterial lens which can be formed on the surface of a silicon wafer. On the other hand, WATIR lens systems 500 (built based on the commonly used fisheye design as shown in FIG. 5) will benefit from the thin graded index metamaterial layer 501 being bent over a spherical front surface. This will reduce aberrations of the fisheye lens while preserving the cost and weight benefits of the graded index metamaterial approach. Only the most expensive front lens 502 pieces of the fisheye lens 500 will be replaced with a graded index metamaterial lens 501. Other smaller and cheaper lenses 504 would not need to be replaced. However, in theory they also could be replaced by metamaterial lenses. In the case of WATIR lens, the metamaterial structure 100 shown in FIG. 1 will be thinned to ˜75 μm thickness, which makes a silicon membrane flexible. The silicon-based graded index metamaterial membrane will be glued onto a thin spherical substrate. The so obtained graded index metamaterial lenses will replace the front elements 502 in the fisheye WATIR design 500 shown in FIG. 5

Those skilled in the art will appreciate that the metamaterial WATIR lens of the present invention is inexpensive and realistic since it requires only realistic and easily obtained refractive indices in the 0<n<3.5 range, and it is making use of the existing proven wide field of view fisheye lens designs, which may provide FOV˜180°.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

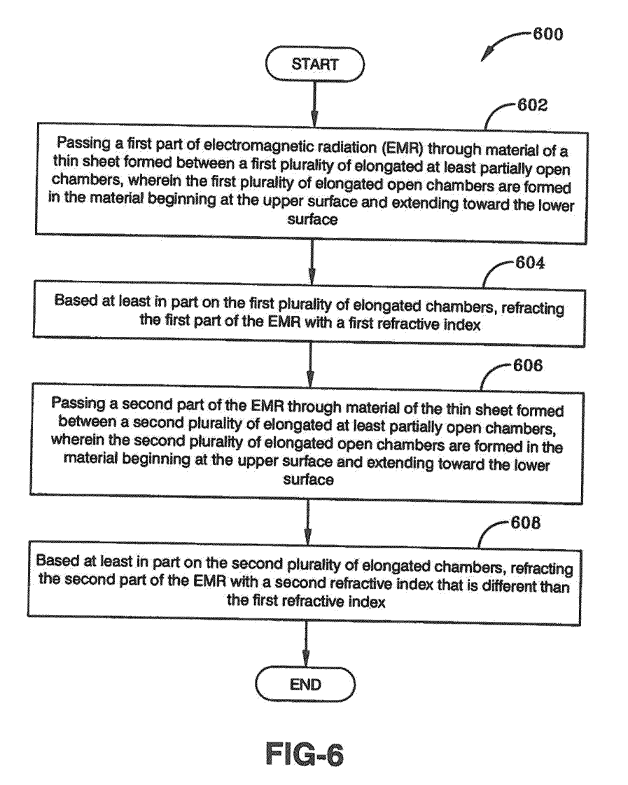

FIG. 6 illustrates a method 600 of refracting electromagnetic radiation using a thin sheet of material having an upper surface and a lower surface. The method 600 passes a first part of the EMR through material of the thin sheet formed with a first plurality of at least partially open chambers, at 602. The first plurality of chambers are formed in the material beginning at the upper surface and extending toward the lower surface. Based at least in part on the first plurality of elongated chambers, the first part of the EMR is refracted with a first refractive index, at 604. A second part of the EMR is passed, at 606, through material of the thin sheet formed with a second plurality of at least partially elongated chambers. These chambers are also formed in the material beginning at the upper surface and extending toward the lower surface. Based at least in part on the second plurality of elongated chambers, the second part of the EMR is refracted, at 608, with a second refractive index that is different than the first refractive index.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A lens for refracting electromagnetic radiation (EMR) comprising:
a sheet of material with a generally uniform thickness having a top surface and a bottom surface for refracting EMR through the material itself, wherein the material is formed with openings extending from the top surface at least partially downward toward the bottom surface, wherein a thickness of material between adjacent openings is smaller than wavelengths of EMR the material is configured to refract.

2. The lens for refracting EMR of claim 1 wherein the holes further comprise:
a first region of holes that has a first density of holes;
a second region of holes that has a second density of holes that is different than the first density of holes, wherein the first region of holes is configured to refract EMR with a first refractive index and the second region of holes is configured to refract EMR with a second refractive index that is different than the first refractive index.

3. The lens for refracting EMR of claim 1 wherein a thickness of the openings is smaller than wavelengths of EMR that the material is configured to refract.

4. The lens for refracting EMR of claim 1 wherein the thickness of material between adjacent openings is at least 10 times smaller than wavelengths of EMR the material is configured to refract.

5. The lens for refracting EMR of claim 1 wherein the material is a graded material with refractive index values that vary across the material.

6. The lens for refracting EMR of claim 1 wherein the refractive index of the material is between 1 and 3.5.

7. The lens for refracting EMR of 1 further comprises:
metal filling the openings.

8. The lens for refracting EMR of claim 7 wherein the metal filling of the opening is one of the group of: aluminum, copper or another metal.

9. The lens for refracting EMR of claim 7 wherein refractive index of the lens with metal filling the openings is between 0 and 1.

10. The lens for refracting EMR of claim 1 wherein the lens is formed out of a semiconductor material.

11. The lens for refracting EMR of claim 1 wherein the lens is formed out of a metamaterial.

12. The lens for retracting EMR of claim 1 wherein t the openings pass completely through the material.

13. The lens for refracting EMR of claim 1 wherein material thickness between the top surface and the bottom surface is thin enough to allow the material to be flexible and curved.

14. The lens for refracting EMR of claim 1 wherein the lens is configured to focus Long-Wave Infrared (LWIR) electromagnetic energy.

15. A method of refracting electromagnetic radiation (EMR) using a thin sheet of material having an upper surface and a lower surface comprising:
passing a first part of the EMR through material of the thin sheet formed between a first plurality of elongated at least partially open chambers, wherein the first plurality of elongated open chambers are formed in the material beginning at the upper surface and extending toward the lower surface;
based at least in part on the first plurality of elongated chambers, refracting the first part of the EMR with a first refractive index;
passing a second part of the EMR through material of the thin sheet formed between a second plurality of elongated at least partially open chambers, wherein the second plurality of elongated open chambers are formed in the material beginning at the upper surface and extending toward the lower surface; and
based at least in part on the second plurality of elongated chambers, refracting the second part of the EMR with a second refractive index that is different than the first refractive index.

16. A lens with a graded index of refraction comprising:
a sheet of material having a uniform thickness with a top surface and a bottom surface;
elongated chambers formed in the top surface and extending downward to the bottom surface;
material of the elongated sheet remains between adjacent chambers, wherein a width of the material between the adjacent chambers is less than a wavelength of electromagnet energy the lens is configured to refract; and
wherein the density and distribution of the chambers varies across the sheet of material so that the graded index of refraction varies across the sheet of material.

17. The lens with a graded index of refraction of claim 16 wherein features on the top surface of the sheet of material are less than the wavelength of electromagnet energy the lens is configured to refract.

18. The lens with a graded index of refraction of claim 16 wherein distances across the chambers on the top surface are less than a wavelength of electromagnet energy the lens is configured to refract.

19. The lens with a graded index of refraction of claim 16 wherein the sheet of material is formed out of a metamaterial.

20. The lens with a graded index of refraction of claim 16 wherein the width of the material between adjacent chambers is at least 10 times smaller than a wavelength of electromagnet energy the lens is configured to refract.

21. The lens with a graded index of refraction of claim 16 further comprising:
metal filling inserted into the elongated chambers.
